(19) United States
(12) Patent Application Publication
(10) Pub. No.: US 2013/0020295 A1
(43) Pub. Date: Jan. 24, 2013

(54) Unloading Device for a Processing Device for Processing Pipes and Related Methods

(71) Applicants: Ralf Schopf, Ditzingen (DE); Florian Jarsch, Ditzingen (DE)

(72) Inventors: Ralf Schopf, Ditzingen (DE); Florian Jarsch, Ditzingen (DE)

(73) Assignee: TRUMPF WERKZEUGMASCHINEN GMBH + CO. KG, Ditzingen (DE)

(21) Appl. No.: 13/551,654

(22) Filed: Jul. 18, 2012

(30) Foreign Application Priority Data
Jul. 22, 2011 (EP) 11 174 965.1

(51) Int. Cl. B26D 7/32; B23K 26/38

(52) U.S. Cl. 219/121.72; 83/160

(57) ABSTRACT

The invention relates to an unloading device for a processing device for processing pipes by cutting, having a catching lance which is movable in the longitudinal direction of a pipe and which is insertable into the interior of a pipe to be processed. The unloading device includes at least one vertically movable, especially roller-shaped, support element for supporting the catching lance and/or includes a vertically movable depositing surface for depositing at least one pipe portion to be severed from the pipe during processing by cutting. The invention also relates to a method for processing a pipe by cutting by a processing device with which such an unloading device is associated.

### CROSS-REFERENCE TO RELATED APPLICATION

This application claims priority under 35 U.S.C. §119 to European Patent Application No. EP 11 174 965.1, filed on Jul. 22, 2011. The contents of this priority application are hereby incorporated by reference in their entirety.

### TECHNICAL FIELD

The present invention relates to an unloading device for a processing device for processing pipes, and to a processing method using such an unloading device.

### BACKGROUND

In the context of this application, a pipe is understood as being an elongate body (an elongate workpiece) the length of which is as a rule considerably greater than its cross-section and which is made from a substantially inflexible material. Pipes may have any closed or open cross-sectional shape, round pipes and rectangular pipes being the commonest pipes. Pipe-shaped components produced from pipes by laser cutting are referred to as pipe parts in the context of this application.

EP 1 923 166 B1 discloses a processing system for laser cutting of pipes, which has a catching lance and a stripper on the unloading device so that pipes can be processed without spatter. The catching lance can be inserted into the interior of the pipe to be processed. Completed cut pipe parts are deposited on the catching lance and, after processing of the pipe, can be stripped off the catching lance by the stripper and unloaded. The catching lance and the stripper are movable in the longitudinal direction of the pipe.

It is known from DE 102 49 106 A1 to arrange in a pipe cutting machine a carriage which is displaceable in a controlled manner and which is capable of carrying various auxiliary devices (e.g. a hollow lance) for supporting, guiding or ejecting the pipes that are to be processed or the pipes that have been processed to completion. The carriage has a horizontal carrier plate for supporting the auxiliary device, which is displaceable in a controlled manner in the vertical direction by servo drives.

### SUMMARY

In some aspects of the invention, an unloading device has a catching lance which is movable in the longitudinal direction (X direction) of a pipe and which is insertable into the interior of a pipe to be processed, and at least one vertically movable, especially roller-shaped, support element for supporting the catching lance and/or a vertically movable depositing surface for depositing at least one pipe portion to be severed from the pipe during processing by cutting. In the case of such an unloading device, the catching lance, the at least one pipe portion or both is/are supported in order to avoid bending or damage of the catching lance when pipe portions fall onto the catching lance or when pipe portions are being carried by the catching lance.

A vertically adjustable support element for the catching lance is a component part of the unloading device, and therefore it is disposed on that side of the rotating and feeding means which is remote from the processing position. In the case of such an unloading device, the support element can be presented vertically to the catching lance and therefore can be used as a support point for the catching lance (or “catcher”). This prevents bending of the lance due to its own weight or due to the weight of pipe portions threaded thereon, and thus results in improved rigidity of the arrangement, a reduction in vibrations and an increase in the lifetime of the catching lance. In that way, better accuracy is also obtained in the processing operation and the production of scratches on the inside of the pipe due to contact between lance and pipe can be avoided.

To prevent bending of the catching lance and damage to the catching lance when cut pipe portions fall onto the catching lance, a depositing surface can be used for supporting the pipe or for supporting pipe portions that are to be severed from the pipe during processing by cutting. The depositing surface is disposed for that purpose in the region of the processing site and, during the processing operation, supports at least one pipe portion that is to be severed. In that case, it is not necessary to catch the severed pipe portions with the catching lance. Instead, the pipe portions can be supported on the depositing surface also after processing by cutting.

Thus, on the one hand, it is possible for the catching lance to remain disposed centrally in the pipe and in the pipe portions and for the inside wall of the pipe not to be touched by the catching lance. On the other hand, the pipe portions can be deposited on the catching lance by a controlled (slow) lowering movement of the depositing surface instead of falling onto the lance in an uncontrolled manner under the effect of gravity. In that way, scratches on the inside of the pipe and damage to the catching lance are avoided. In some embodiments of the unloading device, the two aforementioned measures are combined.

In certain embodiments, a stripper which can be movable in the longitudinal direction of the pipe includes a support element which is configured especially in the form of a support roller. For supporting the catching lance, the support element can be supported on the stripper so as to be movable in the vertical direction. It is advantageous if the stripper itself is supported so as to be movable in the vertical direction, so that, on movement of the stripper in the vertical direction, the support element is also moved in the vertical direction.

The stripper typically includes a stripping element for stripping off the pipe portions disposed on the catching lance, and a support element in the form of one (or more) support roller(s) on which the catching lance is able to rest. On movement of the catching lance relative to the stripper, the catching lance then rolls over the support roller with only little friction, so that neither the stripper nor the catching lance is damaged.

In order to limit the force acting on the catching lance when being supported by the support roller, the stripper and/or the support roller can be spring-mounted in the vertical direction (Z-direction). The stripper and the support roller are in that case typically displaceable against a spring force acting counter to the direction of gravity.

In some embodiments, the stripper has a stripper element which is supported on the stripper so as to be displaceable in the longitudinal or feed direction of the pipe and, typically, against the action of a spring force. Since jamming may possibly occur between a pipe part and the stripper as the pipe parts are being stripped off, it is advantageous if the stripper element, which is typically plate-shaped, is capable of executing a yielding movement in the feed direction of the pipe (in the positive X-direction) as an overload protection in the event of too great a load. The force at which the yielding movement of the stripper element is triggered can be continuously varied, for example by a mechanical force limiter. Triggering of the yielding movement can be detected, for example, by a proximity switch in order to stop the further feed motion of the pipe in the longitudinal direction of the pipe.

In some embodiments, the stripper is attached to a stripper mount which is disposed on a stripper slide, which is displaceable in the longitudinal direction (X direction) of the pipe, in such a manner as to be movable vertically. With such an arrangement, the stripper can be flexibly positioned, that is, the position of the stripper along the catching lance can be flexibly adapted to the various sizes of the pipes to be cut and to the number and size of the pipe portions.

In some embodiments, the depositing surface is formed on a depositing slide which is displaceable in the longitudinal direction (X-direction) of the pipe. The depositing surface of the depositing slide can be displaced (in a controlled manner) not only in the longitudinal direction of the pipe but also in at least one further direction. The movement in the further direction is effected either by moving the depositing slide in its entirety or by the depositing surface being moved relative to the depositing slide which carries it.

The depositing surface can be positioned, during processing of a pipe, beneath the pipe to be deposited or supported and can be presented to the pipe in the Z-direction, so that a severed pipe part does not fall onto the catching lance but is supported from below by the depositing surface. After the end of the processing operation, the catching lance can be withdrawn from the pipe part without touching the pipe part and damaging the surface of the pipe. The severed pipe part can be directly removed from the depositing surface or can be moved by the depositing slide to a different position in the longitudinal direction of the pipe and unloaded there.

If the depositing surface is additionally displaceable in at least one direction other than the longitudinal direction of the pipe, it is also possible to position the stripper slide or the catching lance slide(s) directly at the processing site, for example when thin pipes are to be processed and are to be caught on a thin, short catching lance. In one embodiment, the depositing slide has for that purpose an arm for moving the depositing surface of the depositing slide transversely to the longitudinal direction of the pipe or the machine axis. The depositing surface can in this case be moved away from the longitudinal axis of the machine when the stripper slide or the catching lance slide(s) carrying the catching lance are to be positioned next to the processing site, so that collisions can be avoided in an especially simple manner.

In certain embodiments, the depositing surface is supported on the depositing slide so as to be vertically adjustable. In that case, the stripper slide or the catching lance slide(s) can be moved under the depositing surface, or vice versa. The vertical adjustment of the depositing surface, which can be achieved, for example, by mounting the depositing surface on a slide that is vertically adjustable in a controlled manner, can also be used to present the depositing surface to the enveloping circle of the pipe that is to be supported by the depositing surface.

The depositing surface may, in particular, be prismatic in this case, that is to say may extend upwards to both sides transversely to the longitudinal direction of the pipe from an edge extending in the longitudinal direction of the pipe and forming the vertex of the depositing surface, with the result that pipe parts resting thereon are prevented from rolling or sliding away sideways.

In certain embodiments, the depositing surface of the depositing slide is pivotable between a first, horizontal position for depositing pipe portions that are to be severed from the pipe and a second, tilted position for discharging pipe portions that have been severed from the pipe. A pivoting device, for example in the form of a hydraulic or pneumatic cylinder whose piston acts on a free end of the depositing surface, may be used for pivoting between the two positions. The pivoting movement of the depositing surface enables pipe parts resting thereon to be unloaded in an especially simple manner.

In some embodiments, the unloading device has both a stripper with a support element and a depositing slide with a depositing surface, so that both the catching lance and the pipe or pipe portions can be supported during and after the processing operation. In that manner, especially good stability and precision of the processing operation are obtained.

The catching lance may be disposed on two catching lance mounts which are movable in a vertically adjustable manner, i.e. in the Z-direction perpendicular to the longitudinal direction of the pipe, independently of each other. In that manner, not only can the catching lance be varied in height, for example in order to be presented to the upper inside surface of the pipe, but it can also be set so that it extends obliquely upwards at an angle to the X axis. This allows scratch-free processing of the pipe, particularly when a long, thin lance is used, since it is possible to compensate for bending of the lance due to its own weight which can lead to collisions or to rubbing of the lance against the inside of the pipe on insertion of the lance into the pipe that is to be processed. The catching lance mounts are typically supported so as to be movable in the longitudinal direction (X direction) of the pipe.

The catching lance mounts are provided on two catching lance slides which are movable in the longitudinal direction of the pipe independently of each other. In that manner, the support span of the catching lance mounts can be varied specifically and according to the length and weight of the lance and the diameter and weight of the pipe to be processed. In the case of long lances and heavy pipe parts, the support span can be increased in order to reduce bending of the lance and loading of the mounts.

In some embodiments, the catching lance is supported on at least one catching lance mount so as to be displaceable in the longitudinal direction of the pipe in order to be able to execute a yielding movement in the event that the forces acting on the catching lance (in the positive or negative X-direction) become too great. As in the case of the stripper element, the displacement may take place against the action of a spring force, it likewise being possible for the load at which the yielding movement is triggered to be adjusted by a force limiter. In the case of the catching lance, a compensating movement both in the feed direction of the pipe (in the positive X-direction) and counter to the feed direction (in the negative X direction) is advantageous, since jamming may occur both on insertion and on withdrawal of the lance from the pipe. The occurrence of the compensating movement can be detected by a proximity switch in order to stop further movement of the lance in the longitudinal direction of the pipe.

In some embodiments, the unloading device can have an inclined unloading surface which adjoins the depositing surface transversely to the longitudinal direction of the pipe. The upper end of the inclined unloading surface is disposed in this case at a height that coincides with the height of the lower end of the depositing surface in the tilted position in order to transfer pipes or pipe parts in a controlled manner to collecting containers or transport means. The stationary unloading surface, which extends over the entire travel path of the depositing slide or the catching lance slides in the longitudinal direction of the pipe, prevents the depositing surface from colliding with, and possibly being caught on, badly positioned collecting containers when travelling in the longitudinal direction of the pipe.

The catching lance slide(s), the stripper slide and the depositing slide can be mounted on guide rails of a longitudinal beam extending in the longitudinal direction of the pipe. The guide rails make especially simple and hence inexpensive guiding possible. With the aid of controllable drives, the slides can be moved in a controlled manner along the guide rails independently of one another and be positioned in a desired position along the beam. It will be appreciated that such guide rails can also be mounted directly on the floor of the machine shop, so that the slides are movable directly on the floor. A yielding movement of the depositing slide can in this case be implemented, for example, at a branching point of one of the guide rails where the depositing slide can be moved along a guide rail branch section extending in a direction different from the longitudinal direction of the pipe.

A further aspect of the invention relates to a method for processing a pipe by cutting using a laser processing device with which an unloading device as described above is associated. The method includes inserting the catching lance into the interior of a pipe that is to be cut until a collecting aperture of the catching lance is positioned at a processing site of a laser beam, moving the support element—for example by moving the stripper—and/or the depositing surface in the vertical direction (Z-direction) until the catching lance is supported by the support element and/or the at least one pipe portion to be severed is supported by the depositing surface of the depositing slide, severing the at least one pipe portion from the pipe by the laser beam, and withdrawing the catching lance from the pipe portion.

The catching lance is supported, during processing of the pipe and during stripping-off of cut pipe parts, by the support element of the stripper, with the result that it is able to bend to a lesser extent or not at all, and vibrations are reduced. Alternatively or in addition, the pipe part that has been or is to be severed is supported, during the processing operation and on insertion or withdrawal of the catching lance, by the depositing surface of the depositing slide. In that manner, contact between the catching lance and the inside surface of the pipe can be completely avoided, since the lance is not used for collecting the cut parts but is used only for removal of metal spatter. The lance is inserted and withdrawn in the center of the pipe, and the cut pipe parts remain lying on the depositing surface. Scratches on the inside of the pipe can therefore be avoided. A stripper is not absolutely necessary in that case.

Before or after severing of the at least one pipe portion, the catching lance can be displaced vertically (in the Z-direction) to minimize the distance from the cut edge during the cutting process.

In addition or alternatively, the catching lance can be oriented in the Z-direction at an angle to the longitudinal axis (X-axis) of the pipe when being inserted into the pipe to be cut and/or when being withdrawn from the pipe portion(s). Bending of a long, thin lance is compensated for in that manner and collisions between the lance and the end of the pipe and rubbing of the lance against the inside of the pipe are avoided. Orientation of the catching lance at an angle to the longitudinal axis of the pipe can be effected in this case by positioning the catching lance mounts, on which the catching lance is supported, at different positions in the vertical direction.

The unloading devices described herein can have catching lances that are more stable and more robust, that have increased life spans, and that avoid scratches on the inside of the pipe to be processed.

Further advantages will be apparent from the description and the drawings. The features mentioned above and the features set forth hereinafter may also be used individually or a plurality thereof may be used in any desired combination. The embodiments shown and described are not to be understood as forming a definitive list, but rather are of the nature of examples for illustration.

### DESCRIPTION OF DRAWINGS

FIG. 1 is a schematic illustration of a conventional processing system for laser cutting of pipes,

FIG. 2 is a schematic illustration of an unloading device having a depositing slide, a stripper slide, and a catching lance fastened to two catching lance slides,

FIG. 3 shows a schematic detail of the stripper slide and the catching lance fastened to two catching lance slides, as shown in FIG. 2,

FIG. 4 shows a schematic detail of the stripper slide shown in FIG. 2,

FIG. 5 is a side view of the unloading device with the catching lance in the home or unloading position,

FIG. 6 is a side view of the unloading device with the catching lance in an insertion position for insertion into the pipe that is be processed, and

FIG. 7 is a side view of the unloading device with the catching lance in a working position.

### DETAILED DESCRIPTION

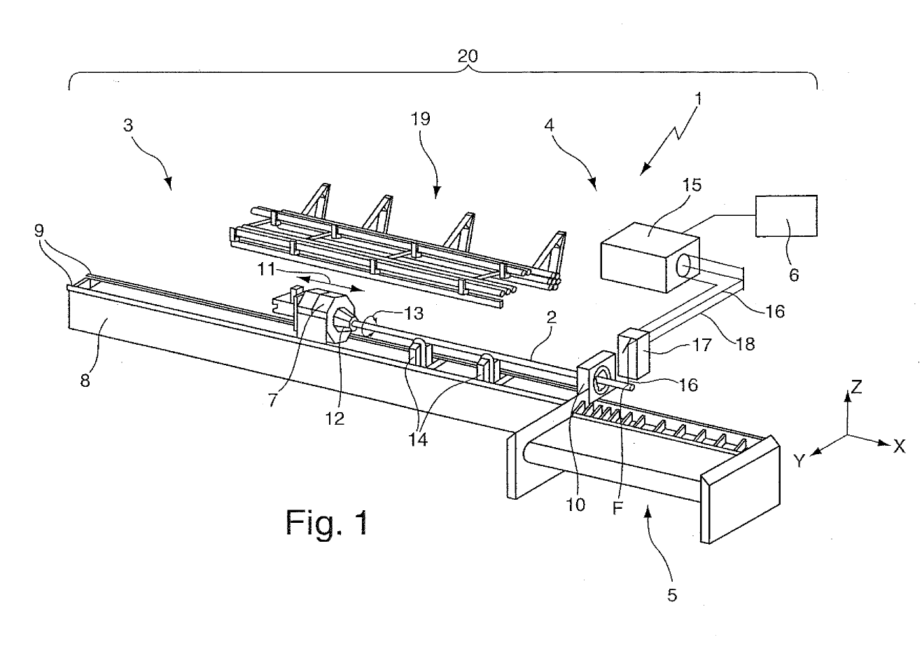

FIG. 1 shows a processing system 1, known as a “TruLaser Tube”, for laser cutting of pipes 2. The processing system 1 is referred to as a laser cutting system and is configured for the processing of pipes of any cross-sectional shape. The laser cutting system 1 shown includes a delivery device 3 for sideways delivery of a pipe 2 that is to be cut to the laser cutting system 1, a processing device 4 for laser cutting of pipe parts from the pipe 2, and an unloading device 5 for unloading the cut pipe parts from the laser cutting system 1. All of the main functions of the laser cutting system 1 are controlled by a numerical control device 6.

The delivery device 3 includes a rotating and feeding means 7, serving as a means for moving the workpiece, and a machine bed 8 having guide rails 9 and a push-through means 10. The rotating and feeding means 7 is displaceable by motor drive in the feed direction 11 on the guide rails 9. On the side towards a pipe 2 that is to be delivered, the rotating and feeding means 7 has a clamping means 12 which is rotatable in a controlled manner in the direction of the double-headed arrow 13 and which surrounds the delivered pipe 2 from the outside and clamps it in a fixed position. The delivered pipe 2 is supported by at least one workpiece support 14 which is integrated in the machine bed 8. In the region of the processing device 4, the pipe 2 is guided through the push-through means 10. The push-through means 10 is configured in such a way that the clamped pipe 2 is guided in the feed direction 11 and is not clamped in a fixed position. The pipe 2 is rotatable in the push-through means 10 in the direction of the double-headed arrow 13.

The processing device 4 includes a laser beam source 15 for generating a laser beam 16, a processing head 17 and a beam guide 18 which guides the laser beam 16 from the laser beam source 15 to the processing head 17. The laser beam 16 emerges from the processing head 17 and is focused onto the outer peripheral surface of the clamped pipe 2 at a processing site F. The unloading device 5, which removes the pipe parts cut from the pipe 2 and also removes the residual pipe from the laser cutting system 1, is provided on the side of the push-through means 10 facing away from the machine bed 8.

In order to increase the productivity of the laser cutting system 1, the laser cutting system 1 shown in FIG. 1 has a loading device 19 as an automation component with which a pipe 2 is automatically conveyed to a transfer position and transferred to the delivery device 3 of the laser cutting system 1. The machine assembly comprising laser cutting system 1 and loading device 19 is referred to as a production cell 20.

When the pipe 2 delivered via the loading device 19 is arranged in the transfer position, the rotating and feeding means 7 is initially in a home position remote from the processing head. For processing of a pipe, the rotating and feeding means 7 travels from its position with opened clamping means 12 in the direction towards the delivered pipe 2 until the end of the pipe 2 facing away from the processing head 17 comes to rest inside the clamping means 12. The clamping means 12 is closed and the pipe 2 is thereby clamped in a fixed position at the rotating and feeding means 7. The rotating and feeding means 7 and the pipe 2 move together in the direction towards the processing head 17. In that operation, the end of the pipe 2 facing the processing head 17 first enters the push-through means 10 and is moved in the feed direction 11 through the push-through means 10, during which operation the pipe 2 is rotatable in the push-through means 10 in the direction of the double-headed arrow 13. By the travel of the rotating and feeding means 7 in the feed direction 11, the pipe 2 is positioned in the desired processing position relative to the processing head 17.

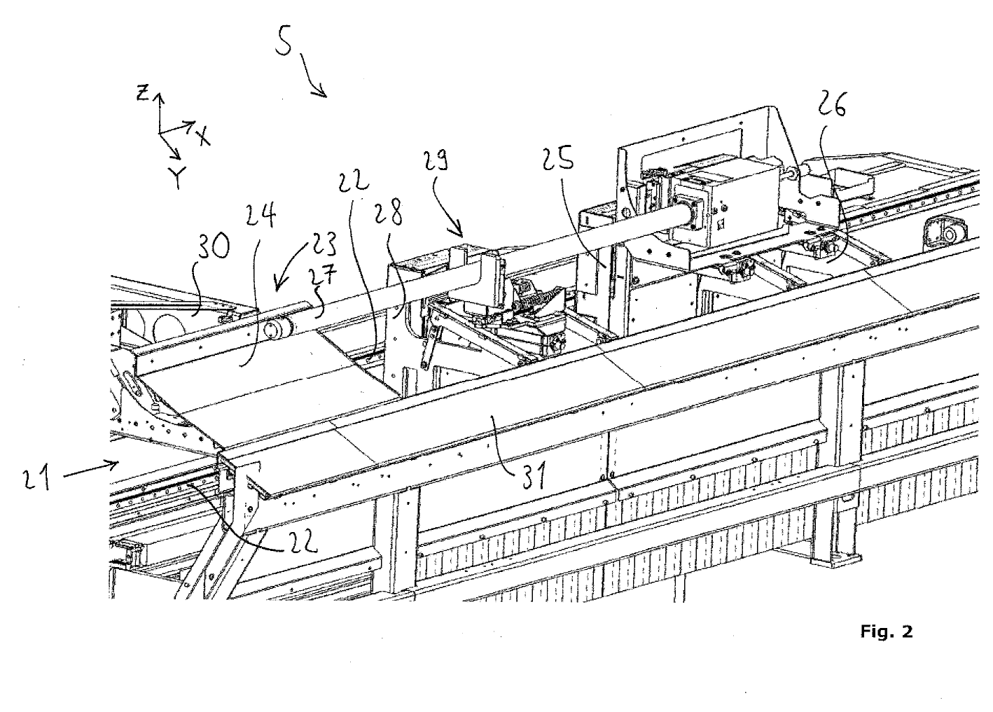

FIG. 2 shows schematically an unloading device 5 of the laser cutting system 1 of FIG. 1. The unloading device 5 has a longitudinal beam 21 which adjoins the machine bed 8 (see FIG. 1) in the longitudinal direction of the pipe (X-direction of an XYZ-coordinate system). Mounted on the beam 21 are guide rails 22 extending in the longitudinal direction X of the pipe.

The unloading device 5 has a depositing slide 23 with a depositing surface 24, a catching lance 27 supported by one end on two catching lance slides 25, 26, and a stripper 29 disposed on a stripper slide 28.

The depositing slide 23 is guided in the longitudinal direction X of the pipe on a guide rail (not shown in FIG. 2) which is mounted on that side of the crossbeam 21 which is remote from the pipe. The depositing slide 23 can be actuated and displaced in a controlled manner by the control device 6 shown in FIG. 1. The depositing surface 24 of the depositing slide 23 is configured in this example as a prismatic depositing table which can be presented and retracted over the top side of the beam 21 in a direction (Y-direction) transverse to the longitudinal direction X of the pipe by an arm 30, so that the depositing surface 24 no longer projects into the region of the side of the beam 21 which is towards the pipe. The transverse arm 30 is mounted on a Z-slide of the depositing slide 23, which Z-slide is displaceable by a drive, so that the depositing surface 24 of the depositing slide 23 can be moved vertically (Z direction) under program control (by the control device 6) and thereby presented to the diameter or enveloping circle of the pipes which have been or are to be processed.

The depositing surface 24 of the depositing slide 23 shown in FIG. 2 is pivotable between a first and a second angular position. In the first, horizontal, position (not shown in FIG. 2), pipe parts are deposited on the depositing surface 24 without rolling or sliding off. In this case, when pipe parts are being severed from the unprocessed pipe, the depositing slide 23 is positioned beneath the respective pipe part to be deposited. The prismatic depositing surface 24 extending upwards towards the sides prevents pipes or pipe parts that are resting thereon from rolling or sliding away sideways. Pipe parts deposited in the horizontal position on the depositing surface 24 can subsequently be transported to another position along the beam 21 by travel of the depositing slide 23 in the longitudinal direction X of the pipe and can there be unloaded manually or by tilting of the depositing surface 24. In that manner, sorting of the parts into various containers along the machine bed or the beam 21 is possible. To discharge pipe parts at different positions along the longitudinal axis X of the unloading device 5, the depositing slide 23 is moved under program control in the longitudinal direction X of the pipe. A hydraulic cylinder serves to pivot the depositing surface 24 out of the first, horizontal position into the second, tilted position (shown in FIG. 2) and vice versa. For that purpose, a free end of the depositing surface 24 is coupled to a piston rod of the hydraulic cylinder for movement therewith.

To ensure reliable unloading of the pipe parts and a defined transfer to collecting containers or transport means, an inclined unloading surface 31, which extends in the longitudinal direction X of the pipe over the entire beam 21, is mounted on the machine bed. An upper end of the unloading surface 31 in this case adjoins a lower end of the depositing surface 24 in its tilted position. The unloading surface 31 serves, for example, to prevent the moving depositing surface 24 from becoming caught on badly positioned collecting containers. The inclined unloading surface 31 is typically disposed with its lower end at a height (Z-direction) such that the pipe parts can be discharged into Euro pallet cages (discharge height 900 mm) without additional lifting means.

The depositing surface 24 of the depositing slide 23 can be taken by the transverse arm 30 to a retracted position at the side of the beam 21 remote from the pipe. The depositing surface 24 can thus be moved away from the longitudinal machine axis in the Y-direction, for example when the stripper slide 28 is to be arranged directly adjacent to the processing position (shown in FIG. 1).

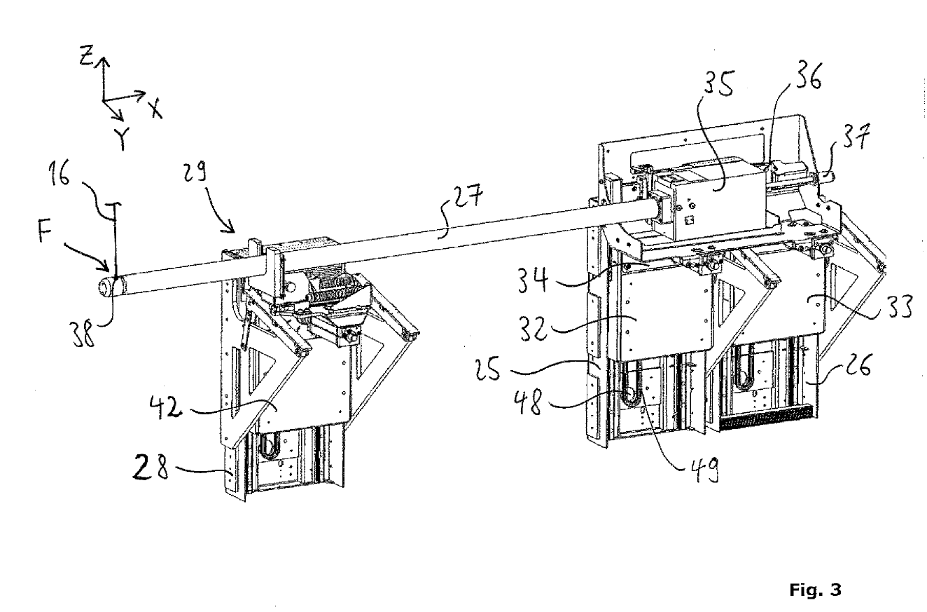

As will be seen in FIG. 3, the catching lance 27 is supported on two catching lance mounts 32, 33 each provided on a respective catching lance slide 25, 26 which is movable in the longitudinal direction X of the pipe. The catching lance 27 projects forwards towards the rotating and feeding means 7 (shown in FIG. 1) in the longitudinal direction X of the pipe. The catching lance slides 25, 26 are each coupled to a respective drive unit of a motor-powered catching lance drive. The drive unit has an electric drive motor. The latter drives a drive pinion which in turn is engaged by a drive rack mounted on the crossbeam 21.

Via the motor-powered drives, the catching lance slides 25, 26 are movable in coupled relationship and together with the catching lance 27 in the longitudinal direction X of the pipe. During their travel, the catching lance slides 25, 26 are guided by a longitudinal guide. The longitudinal guide is a conventional linear guide comprising a guide rail mounted on the beam 21. A longitudinal guide of conventional construction disposed on the catching lance side and provided on the catching lance slides 25, 26 cooperates in customary manner with the guide rail.

As indicated in FIG. 3, the catching lance mounts 32, 33 are vertically adjustable independently of each other by a respective electric motor disposed on the rear side of the catching lance slides 25, 26 (not visible in FIG. 3) by pinions 48 and toothed belts 49. By positioning the catching lance mounts 32, 33 in different Z-positions, the catching lance 27 can be oriented at an angle to the longitudinal axis X of the pipe, as will be described in greater detail hereafter.

If the catching lance 27 is to be employed exclusively in the horizontal orientation and is not to be varied in respect of its angle relative to the X-axis, the two catching lance mounts 32, 33 can be mechanically (rigidly) coupled to each other, for example by a bridging plate 34. In that manner, the moments produced by the catching lance 27 and by the pipe parts resting thereon can be absorbed in combination, thereby improving the stability and rigidity of the arrangement. The catching lance 27 is supported at a lance coupling 35 which is disposed on the bridging plate 34 and which allows the catching lance 27 to be replaced. The lance coupling 35 is supported so as to be displaceable on a guide rail 36 in the longitudinal direction X of the pipe in order to allow a yielding movement of the catching lance 27 in the event of collisions on insertion of the catching lance 27 into the pipe 2 or on withdrawal of the catching lance 27 from the pipe 2. The force in the X-direction at which the compensating movement is triggered can be continuously varied by a mechanical force limiter 37. The triggering force can be adapted in this case according to the weight and dimensions of the pipe 2 to be processed and according to the size and length of the catching lance 27.

The catching lance 27 is provided at its free end with a collecting aperture 38 which can be seen in FIG. 3. In its construction and mode of operation, the catching lance 27 corresponds, for example, to the cooling and/or flushing lance described in EP 1 454 700 A1. Alternatively, it can be in the form of a “sacrificial lance” without the flushing function. In that case, the catching lance is provided at its end with a ladle-shaped collecting aperture 38 without flushing fluid access, in order to collect weld spatter. When a pipe is being processed by cutting, the collecting aperture 38 is situated in the interior of the pipe 2 to be processed, beneath the processing site F of the laser cutting beam 16 (shown in FIG. 1).

In the case of a flushing lance, metal spatter produced in the interior of the pipe 2 passes through the collecting aperture 38 into the interior of the catching lance 27 where it is removed with the aid of a flushing medium. The flushing medium is introduced into the catching lance 27 and—laden with contaminants—is removed from the catching lance 27 via hoses. The inlet and outlet lines for the flushing medium are accommodated in a protected manner in the interior of a drag chain fastened to the catching lance slides 25, 26.

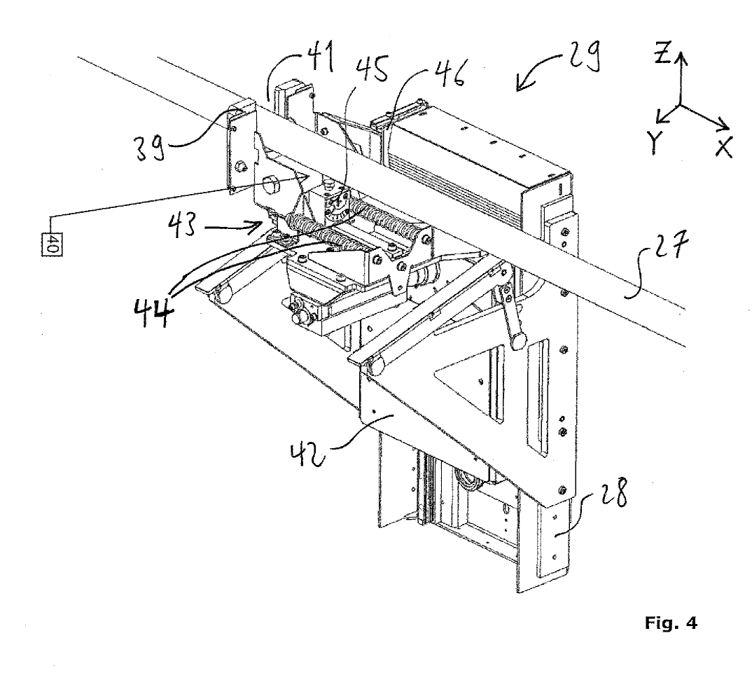

In FIG. 4, a stripper 29 is shown in detail. The stripper 29 includes a stripper element 39 and a support element in the form of a support roller 40. The stripper element 39 is of a plate-like configuration and has a U-shaped passage 41 through which the catching lance 27 passes. The support roller 40 is rotatably supported on a stripper mount 42 and serves to support the catching lance 27 during laser cutting and on unloading of pipe portions. In order to limit the force acting on the catching lance 27 due to the support roller 40, the stripper mount 42 is spring-mounted in the Z-direction and is vertically displaceable (in the Z-direction) relative to the stripper slide 28.

The stripper slide 28 with the stripper 29 is coupled to a drive unit of a motor-powered stripper drive. The drive unit of the motor-powered stripper drive includes an electric drive motor. The latter drives a drive pinion which meshes with an opposite set of teeth of the drive rack. Accordingly, the drive rack forms on the support structure side a drive means that is shared by the motor-powered catching lance drive and the motor-powered stripper drive. Via the motor-powered stripper drive, the stripper slide 28 is displaceable with the stripper 29 in the longitudinal direction X of the pipe relative to the laser cutting head 17. To guide the stripper slide 28 and the stripper 29 during movement thereof in the longitudinal direction X of the pipe, a longitudinal stripper guide, not described in greater detail, is used. The longitudinal stripper guide also is a conventional linear guide.

Since jamming may occur between the catching lance 27 and a respective pipe portion and the stripper 29 or the stripper element 39 when pipe portions are being stripped off, it is necessary for the stripper element 39 to be able to yield if there is too high a load in the direction of movement of the pipe 2 (i.e. in the positive X-direction). For that purpose, there is provided on the stripper mount 42 an overload protection device 43 comprising two tension springs 44 and a further mechanical force limiter 45. The length to which the stripper element 39 is able to yield in the longitudinal direction X of the pipe is given by the spring travel of the two tension springs 44 and is, for example, 120 mm. The force at and above which the yielding movement is triggered can be set manually via the mechanical force limiter 45 in a continuous manner in a range of approximately from 100 N to 1500 N in dependence on the weight of the pipe parts and the lance 27. The force that has been set is indicated by a pointer on the force limiter 45. Triggering of the yielding movement is detected by a proximity switch 46 mounted on the stripper slide 28. The associated switch lug is configured in such a way that it continues to cover the proximity switch 46 also when the stripper mount 42 travels vertically. On triggering of the proximity switch 46, the travel of the catching lance slides 25, 26 is stopped.

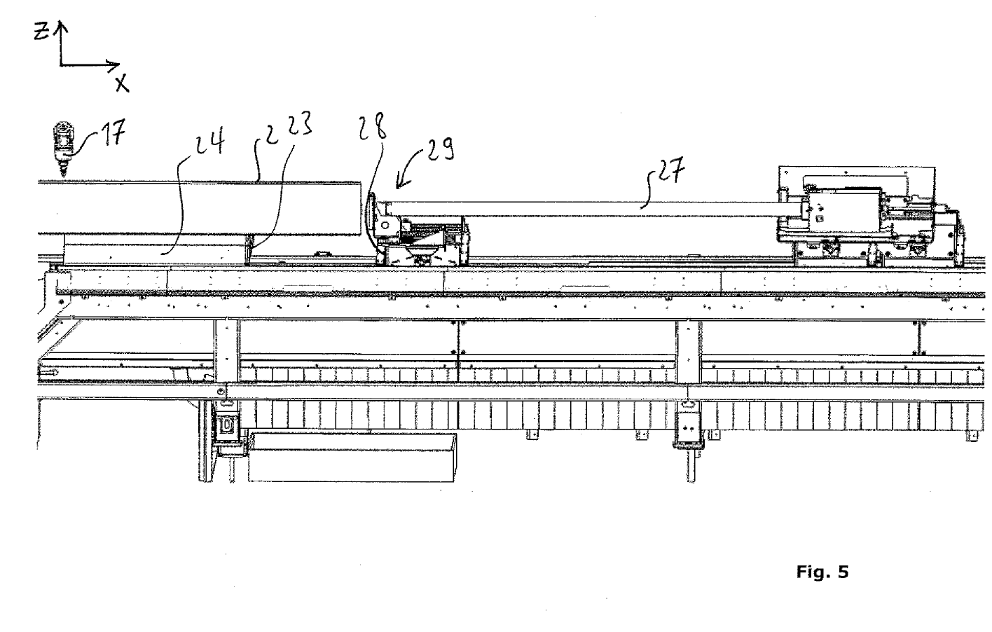

The sequence involved in the processing of a pipe can be seen by reference to FIGS. 5, 6 and 7.

In FIG. 5, the unloading side of the unloading device 5 is shown in side view. In this example, a pipe 2 of relatively large diameter is to be processed. The catching lance 27 is shown with a distinctly smaller diameter in order to be able to distinguish it better. The catching lance 27 projecting into the interior of the pipe 2 may, however, also have a larger diameter matching the diameter of the pipe. A large catching lance diameter in turn permits a great length of the catching lance, since for the flushing medium in the interior of catching lance 27 it is possible to provide flow cross-sections that permit functionally reliable delivery and removal of flushing medium even over relatively great distances. In addition, a large diameter of the catching lance 27 offers the possibility of providing the catching lance with the increased inherent rigidity that is to be demanded in the case of a great length.

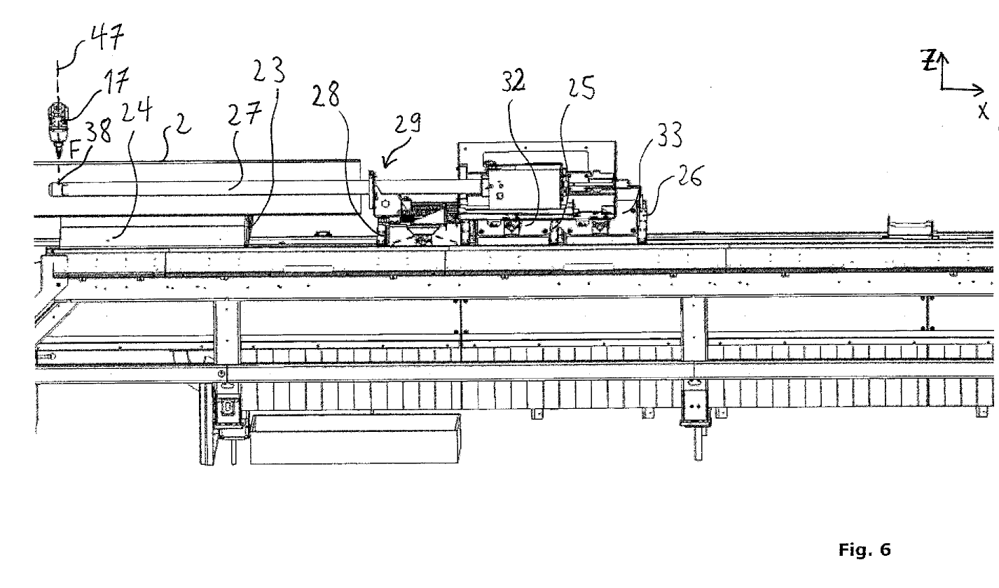

Before processing of a pipe by cutting is commenced, with the laser cutting beam switched off, first the catching lance 27 and the stripper 29 are positioned in the longitudinal direction X of the pipe as shown in FIG. 6. For that purpose, the catching lance slides 25, 26 are positioned under numerical control in the longitudinal direction X of the pipe by the motor-powered drives in such a way that the processing axis 47 of the laser cutting head 17 passes through the collecting aperture of the catching lance 27. In that operation, the catching lance 27 runs at the free end of the pipe 2 to be processed into the interior of the pipe. The end of the pipe then projects by the desired distance beyond the processing axis 47 of the laser cutting head 17 towards the unloading side of the unloading device 5.

If, when the catching lance 27 is of a great length, bending thereof due to its own weight occurs, this can be compensated for by inclining the lance 27. For this, the catching lance mount 32 of the catching lance slide 25 which is closer to the laser cutting head 17 is moved upwards relative to the catching lance mount 33 remote from the cutting head. Thus, the catching lance 27 is able to extend into the interior of the pipe 2 with only a slightly larger internal diameter without damaging the inside surface of the pipe 2. It will be appreciated that the inclination of the catching lance 27 may, where appropriate, be altered along its travel path in the longitudinal direction 27 of the pipe.

Before processing, the stripper slide 28 is moved by the motor-powered stripper drive, which is likewise numerically controlled, in the longitudinal direction X of the pipe to a position in which it is spaced from the processing axis 47 of the laser cutting head 17 in the longitudinal direction X of the pipe by a distance that is matched to the overall length of the finished part(s) to be unloaded after processing of the pipe. Hence, the projecting length of the catching lance 27 relative to the stripper 29 on the cutting head side is likewise matched to the overall length of the finished parts to be unloaded. The depositing slide 23 can be positioned beneath the pipe 2 and be presented to the pipe 2 in the Z-direction. In that manner, the pipe 2 is supported by the depositing surface 24 during and/or after the processing operation. This is advantageous when heavy pipes are to be cut or when unloading is to be performed without causing scratches. In the unloading position shown in FIG. 6, the depositing slide 23 is disposed beneath the pipe 2, between the cutting head 17 and the stripper slide 28. When thin-walled pipes are to be processed or when short pipe parts are to be cut, supporting by the depositing surface 24 is not necessary or is even a hindrance. In that case, the depositing surface 24 can be taken by the transverse arm 30 (shown in FIG. 2) to a retracted position at the side of the beam 21 remote from the pipe 2, so that that stripper slide 28 can be positioned directly adjacent to the processing position F.

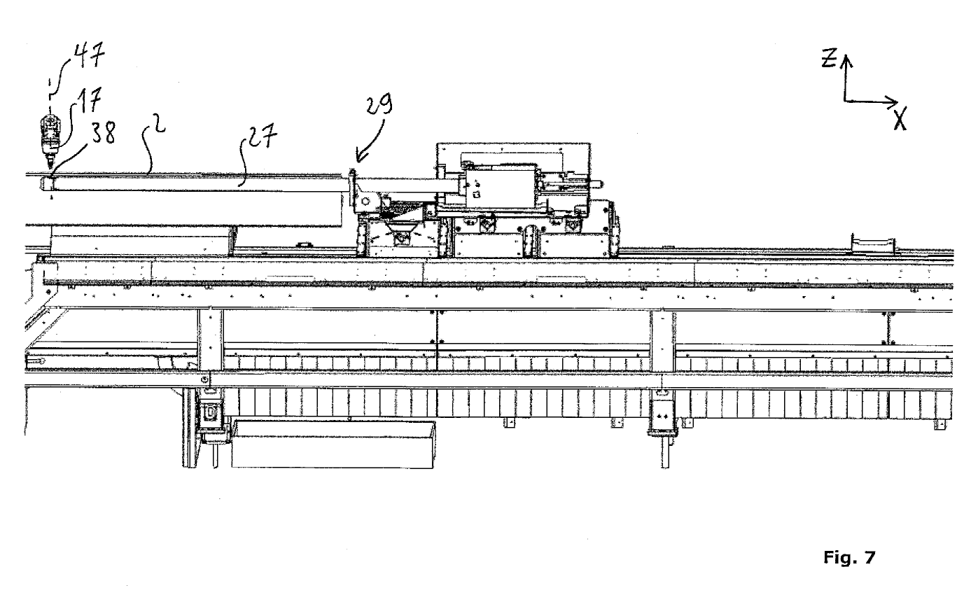

As shown in FIG. 7, after entering the pipe 2 the catching lance 27 is raised in the Z direction by movement of the catching lance mounts 32, 33 and is positioned just (for example about 3 mm) below the upper inside of the pipe. The stripper 29 is also raised in the Z-direction, so that the support roller 40 supports the catching lance 27.

Now, with the rotating and feeding means 7 in a fixed position in the longitudinal direction X of the pipe and with the laser cutting beam 16 switched on, the chuck 12 of the rotating and feeding means 7, with the pipe 2 fixed thereto, is rotated through 360° in the circumferential direction of the pipe. In that rotational movement, a continuous severing cut in the circumferential direction of the pipe is made in the pipe 2. Contamination of the inside wall of the pipe by metal spatter formed during the cutting operation is prevented by the catching lance 27. A pipe portion severed from the pipe 2 by the severing cut either is automatically deposited under the effect of gravity on the catching lance 27 or is supported from below by the depositing surface 24 of the depositing slide 23 and, where appropriate, deposited on the catching lance 27 by controlled downward travel of the depositing surface 24.

Then, with the laser cutting beam 18 switched off, the pipe 2 is repositioned by moving the rotating and feeding means 7 in the direction towards the laser cutting head 17. In that operation, the pipe portion threaded on the catching lance 27 is pushed by the leading end of the pipe 2 in the direction towards the stripper 29. When the repositioning movement has been completed, with the rotating and feeding means 7 stationary in the longitudinal direction X of the pipe and with the laser cutting beam 16 switched on, a further severing cut is made by rotating the pipe 2 through 360°. A pipe portion severed in that operation also comes to rest automatically, or with support by the depositing surface 24, on the catching lance 27. The described severing operation can be repeated a further number of times, so that further pipe portions are severed and are likewise threaded on the catching lance 27 until the projecting length of the catching lance 27 relative to the stripper 29 on the cutting head side is extensively occupied by the pipe portions.

For unloading of the pipe portions, the depositing surface 24 of the depositing table 23 is pivoted into the tilted, unloading position. The catching lance 27 then travels under numerical control out of its working position shown in FIG. 7 into the unloading position shown in FIG. 5. In that operation, the catching lance 27 executes a relative movement with respect to the stripper 29. Owing to that relative movement, the pipe portions, the diameter of which exceeds the width of the passage 41 in the stripper 29, are stripped off the catching lance 27 by the stripper 29. The pipe portions fall under the effect of gravity onto the (tilted) depositing surface 24 of the depositing table 23 and then roll or slide onto the inclined unloading surface 31 from which they are deposited in containers for finished parts, not shown in detail, and are finally removed from the vicinity of the laser cutting system 1.

Alternatively, the depositing surface 24 of the depositing table 23 can be set in the horizontal position during outward travel of the catching lance 27. In that case, the pipe portions fall onto the depositing surface 24 and remain lying there. By displacement of the depositing slide 23 along the beam 21 and by subsequent tilting of the depositing surface 24, the pipe parts can be unloaded at the desired position.

In the case of heavy pipes or when scratching of the interior of a pipe on withdrawal of the catching lance 27 is to be avoided, unloading of the cut pipe parts is carried out with the aid of the depositing slide 23. In this case, during the severing cut the pipe 2 is supported from below by the—horizontally positioned—depositing surface 24. The cut pipe parts remain lying on the depositing surface 24 and are not deposited on the catching lance 27. When processing has ended, the catching lance 27 is lowered in the Z-direction to the center of the pipe and is withdrawn from the cut pipe parts without touching the inside surfaces of the pipes. The finished pipe parts can then be taken by the depositing slide 23 to any positions along the beam 21 and unloaded by tilting of the depositing surface 24.

A number of embodiments have been described. Nevertheless, it will be understood that various modifications may be made without departing from the spirit and scope of the invention. Accordingly, other embodiments are within the scope of the following claims.

What is claimed is:

1. An unloading device for a processing device for processing pipes by cutting, the unloading device comprising:
a catching lance which is movable in a longitudinal direction of a pipe to be processed and which is insertable into an interior of the pipe; and
at least one of:
a vertically movable support element for supporting the catching lance and/or a vertically movable depositing surface for depositing at least one pipe portion to be severed from the pipe during processing by cutting.

2. The unloading device according to claim 1, wherein the depositing surface is formed on a depositing slide which is displaceable in the longitudinal direction of the pipe.

3. The unloading device according to claim 2, wherein the depositing slide is displaceable transverse to the longitudinal direction of the pipe or has an arm for displacing the depositing surface of the depositing slide transverse to the longitudinal direction of the pipe.

4. The unloading device according to claim 2, wherein the depositing surface is supported on the depositing slide so as to be vertically adjustable.

5. The unloading device according to claim 2, wherein the depositing surface of the depositing slide is prismatic in such a manner that it extends upwards to both sides transversely to the longitudinal direction of the pipe from an edge extending in the longitudinal direction of the pipe and forming a vertex of the depositing surface.

6. The unloading device according to claim 2, wherein the depositing surface of the depositing slide is pivotable between a first position for depositing pipe portions and a second position for discharging pipe portions.

7. The unloading device according to claim 1, wherein the support element is roller-shaped.

8. The unloading device according to claim 1, further comprising a stripper which is movable in the longitudinal direction of the pipe and which includes the support element for supporting the catching lance, wherein the stripper or the support element on the stripper is supported so as to be movable in the vertical direction.

9. The unloading device according to claim 8, wherein at least one of the stripper and the support element is/are spring-mounted in the vertical direction.

10. The unloading device according to claim 8, wherein the stripper has a stripper element which is supported on the stripper so as to be displaceable in the longitudinal direction of the pipe.

11. The unloading device according to claim 8, wherein the stripper has a stripper mount which is supported on a stripper slide, which is displaceable in the longitudinal direction of the pipe, in such a manner as to be movable in the vertical direction.

12. The unloading device according to claim 1, wherein the catching lance is supported on at least one catching lance mount so as to be displaceable in the longitudinal direction of the pipe.

13. A method for processing a pipe by cutting using a laser processing device with an unloading device, the method comprising:
inserting a catching lance into an interior of a pipe that is to be cut, until a collecting aperture of the catching lance is positioned at a processing site of a laser beam,
moving at least one of a support element and a depositing surface in the vertical direction until the catching lance and/or at least one pipe portion to be severed is supported,
severing the at least one pipe portion from the pipe using the laser beam, and
withdrawing the catching lance from the pipe portion.

14. A method according to claim 13, wherein the catching lance is displaced in the vertical direction before or after severing of the at least one pipe portion.

15. A method according to claim 13, wherein the at least one pipe portion does not rest on the catching lance on withdrawal of the catching lance.
